(19) United States
(12) Patent Application Publication
(10) Pub. No.: US 2026/0246099 A1
(43) Pub. Date: Aug. 20, 2026

(54) BUSBAR

(71) Applicant: TOYOTA JIDOSHA KABUSHIKI KAISHA, Toyota-shi (JP)

(72) Inventors: Koshiro AONO, Toyota-shi (JP); Takayuki SUGIYAMA, Nisshin-shi (JP); Hiroki OHTSUBO, Toyota-shi (JP); Hiroaki IWATA, Toyota-shi (JP); Satoshi TABARA, Miyoshi-shi (JP)

(73) Assignee: TOYOTA JIDOSHA KABUSHIKI KAISHA, Toyota-shi (JP)

(21) Appl. No.: 19/462,249

(22) Filed: Jan. 28, 2026

(30) Foreign Application Priority Data
Feb. 14, 2025 (JP) 2025-022791

(51) Int. Cl. H01M 50/507; H01B 5/02; H01M 50/503; H01M 50/51

(52) U.S. Cl. CPC H01M 50/507; H01B 5/02; H01M 50/503; H01M 50/51

(57) ABSTRACT

A busbar includes: a first plate portion including a first connection portion that is connected to a terminal of one of two battery cells; a second plate portion including a second connection portion that is connected to a terminal of the other battery cell; a first rising wall connected to an edge of the first plate portion that faces the second plate portion; a second rising wall connected to the second plate portion; a central plate portion connecting the first and second rising walls; and first and second through holes provided in a region between the first and second connection portions and are arranged in an up-down direction. A first auxiliary through hole is provided at a connection portion between the first rising wall and the first plate portion. A second auxiliary through hole is provided at a connection portion between the second rising wall and the second plate portion.

### CROSS-REFERENCE TO RELATED APPLICATION

This application claims priority to Japanese Patent Application No. 2025-022791 filed on February 14, 2025. The disclosure of the above-identified application, including the specification, drawings, and claims, is incorporated by reference herein in its entirety.

### BACKGROUND

### 1. Technical Field

The present disclosure relates to busbars.

### 2. Description of Related Art

Japanese Unexamined Patent Application Publication No. 2022-7032 (JP 2022-7032 A) discloses a technique in which slits (through holes) are formed in a busbar that connects terminals provided on the outer surfaces of battery cells arranged in a predetermined direction.

### SUMMARY

If the busbar is too rigid, it tends to separate from the terminals of the battery cells when the battery cells are displaced by an external force. If too many through holes are provided in the busbar, the busbar has reduced heat dissipation performance.

The disclosure disclosed in JP 2022-7032 A still has room for improvement in terms of suppressing an increase in the rigidity of the busbar while also suppressing an increase in the temperature of the busbar.

In view of the above, an object of the present disclosure is to provide a busbar capable of suppressing increases in both rigidity and temperature.

A busbar of a first aspect is a busbar having a plate shape and made of an electrically conductive material. Terminals are provided on two surfaces of each of two battery cells arranged in a predetermined direction. The busbar is configured to be connected to the terminals on one of the two surfaces of each of the battery cells. The two surfaces face each other in a perpendicular direction that is perpendicular to both the predetermined direction and an up-down direction. The busbar includes: a first plate portion including a first connection portion configured to be connected to the terminal of one of the two battery cells; a second plate portion including a second connection portion configured to be connected to the terminal of the other of the two battery cells; a first rising wall extending away from the battery cells in the perpendicular direction from an edge of the first plate portion that faces the second plate portion; a second rising wall extending away from the battery cells in the perpendicular direction from an edge of the second plate portion that faces the first plate portion; a central plate portion connecting opposing edges of the first rising wall and the second rising wall; and a first through hole and a second through hole that are provided in a region between the first connection portion and the second connection portion and are arranged in the up-down direction. A first auxiliary through hole is provided at a connection portion between the first rising wall and the first plate portion. A second auxiliary through hole is provided at a connection portion between the second rising wall and the second plate portion.

In the busbar of the first aspect, the connection portion between the first rising wall and the first plate portion and the connection portion between the second rising wall and the second plate portion are portions that have a significant influence on the rigidity of the busbar. Therefore, when the first auxiliary through hole and the second auxiliary through hole are formed in these portions, the rigidity of the busbar is likely to be reduced even when the first auxiliary through hole and the second auxiliary through hole are small. Accordingly, there is little likelihood that the first auxiliary through hole and the second auxiliary through hole will cause a significant increase in the electrical resistance of the busbar. It is therefore possible to suppress an increase in the rigidity of the busbar.

Since the first auxiliary through hole and the second auxiliary through hole can be made smaller, the heat dissipation region of the busbar is less likely to be reduced in size and the electrical resistance of the busbar is less likely to increase. Accordingly, the busbar is less likely to become high in temperature.

In a busbar of a second aspect, in the first aspect, the first auxiliary through hole is provided in a connection portion between the first rising wall and the central plate portion, and the second auxiliary through hole is provided in a connection portion between the second rising wall and the central plate portion.

In the busbar of the second aspect, the first auxiliary through hole is also provided in the connection portion between the first rising wall and the central plate portion, and the second auxiliary through hole is also provided in the connection portion between the second rising wall and the central plate portion. Accordingly, it becomes easier to suppress an increase in the rigidity of the busbar.

In a busbar of a third aspect, in the first or second aspect, the first auxiliary through hole and the second auxiliary through hole are located above, below, or both above and below a region between a straight line connecting an upper end of the first connection portion and an upper end of the second connection portion and a straight line connecting a lower end of the first connection portion and a lower end of the second connection portion.

Current readily flows through the region between the straight line connecting the upper ends of the first connection portion and the second connection portion and the straight line connecting the lower ends of the first connection portion and the second connection portion. In the busbar of the third aspect, the first auxiliary through hole and the second auxiliary through hole are located above, below, or both above and below this region. Accordingly, there is little likelihood that the first auxiliary through hole and the second auxiliary through hole will cause an increase in the electrical resistance of the busbar.

In a busbar of a fourth aspect, in the first or second aspect, the first connection portion and the second connection portion are located on either the upper side or the lower side relative to the central position of the busbar in the up-down direction, and the total opening area of portions of the first through hole, the second through hole, the first auxiliary through hole, and the second auxiliary through hole located on the same side relative to the central position as the first connection portion and the second connection portion is greater than 50% of the total opening area of the first through hole, the second through hole, the first auxiliary through hole, and the second auxiliary through hole.

In the busbar of the fourth aspect, the portion of the busbar where the first connection portion and the second connection portion are provided tends to have a reduced rigidity. Accordingly, the connection between the first and second connection portions and the terminals of the battery cells is more likely to be maintained.

As described above, the busbar according to the present disclosure is excellent in that it can suppress increases in both rigidity and temperature.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a portion of a battery module including busbars according to an embodiment, as viewed from the left side;

FIG. 2 is a perspective view of a portion of the battery module, as viewed from the right side;

FIG. 3 is an exploded perspective view of a busbar and two battery cells; and

FIG. 4 is a side view of a busbar and two battery cells.

### DETAILED DESCRIPTION OF EMBODIMENTS

A battery module 10 provided with a busbar according to an embodiment will now be described with reference to the accompanying drawings. Arrows UP, FR, LH in the drawings indicate the upper side in the vehicle up-down direction, the front side in the vehicle front-rear direction (predetermined direction), and the left side in the vehicle left-right direction (perpendicular direction), respectively.

The battery module 10 of the present embodiment is mounted on a vehicle via a case (not shown). The vehicle of the present embodiment is a battery electric vehicle.

The case of the present embodiment houses at least one battery module 10. The electric power of the battery module 10 is supplied to, for example, an electric motor (not shown) that applies driving force to the drive wheels of the vehicle.

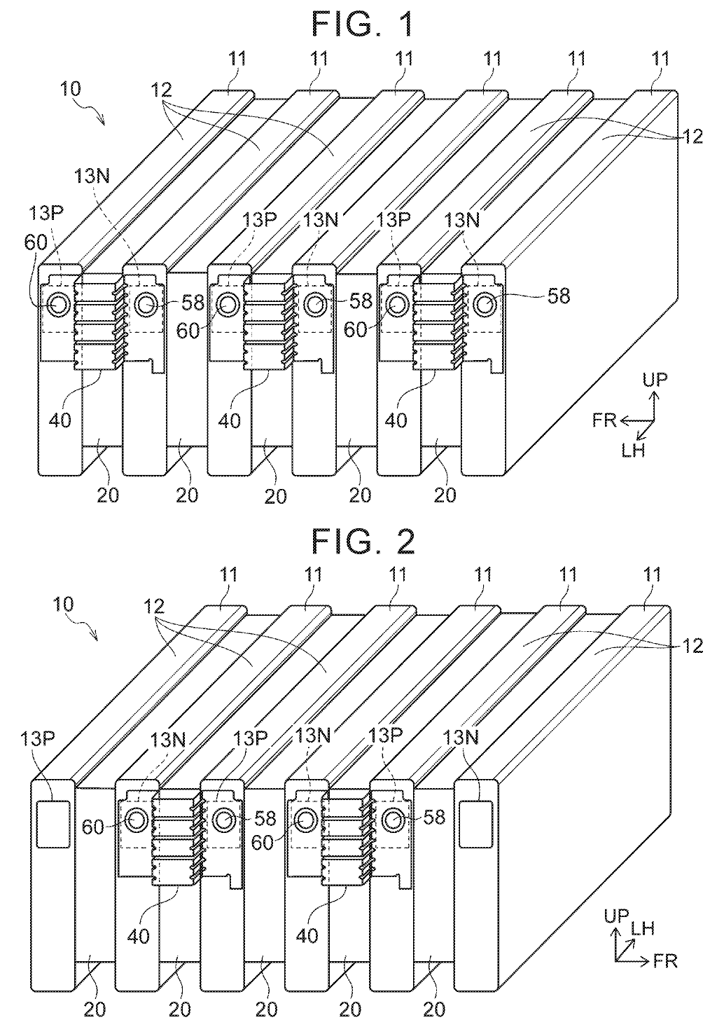

As shown in FIG. 1, the battery module 10 includes: a plurality of battery cells 11 that is lithium-ion secondary cells; a plurality of separators 20 that is insulating members each positioned between corresponding adjacent battery cells 11; a plurality of busbars 40; and a restraining member.

Each battery cell 11 has a metal cell case 12 in the form of a rectangular parallelepiped. The cell case 12 has a rectangular shape with its left-right dimension greater than its up-down dimension when viewed from the front. As shown in FIGS. 1 and 2, a positive terminal (terminal) 13P is provided on one of the right and left end faces of each cell case 12, and a negative terminal (terminal) 13N is provided on the other of the right and left end faces. The positive terminal 13P and the negative terminal 13N are made of metal. In the present embodiment, as shown in FIGS. 1 and 2, the battery cells 11 are oriented in the left-right direction such that the positive terminals 13P and the negative terminals 13N of the battery cells 11 are alternately arranged in the front-rear direction.

Each separator 20 is made of resin and is in the form of a substantially rectangular parallelepiped.. Each separator 20 is positioned between a corresponding pair of battery cells 11.

The battery cells 11 and the separators 20 are restrained by the restraining member (not shown). Accordingly, each separator 20 and its adjacent battery cells 11 are in contact with each other.

Next, the busbars 40 made of metal will be described. The busbars 40 are made of, for example, a highly electrically conductive metal material such as copper.

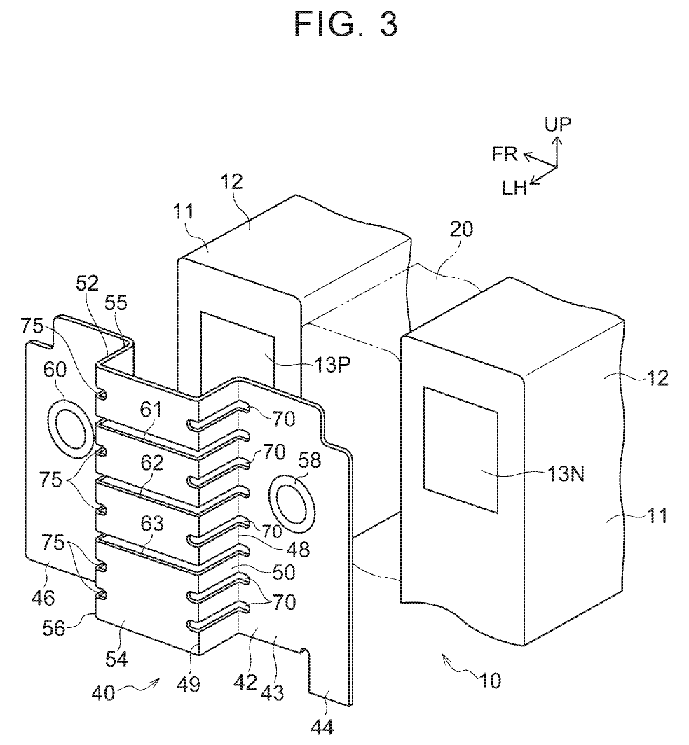

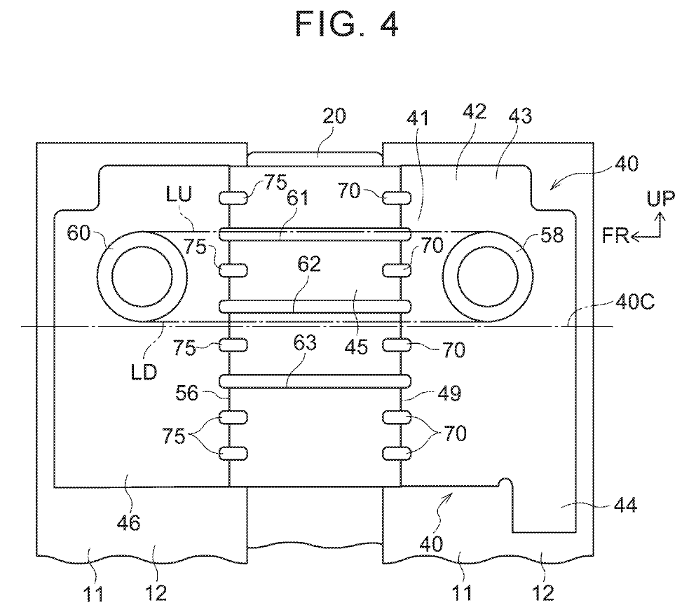

As shown in FIGS. 3 and 4, the busbar 40 is an integrally formed component including a first plate portion 42, a second plate portion 46, a first rising wall 50, a second rising wall 52, and a central plate portion 54. The busbar 40 of the present embodiment is manufactured by, for example, press-forming a metal plate.

The first plate portion 42 and the second plate portion 46 are portions in the form of a flat plate. The first plate portion 42 includes a body portion 43 having a substantially rectangular shape when viewed from the side, and a lower extension portion 44 extending downward from the body portion 43. The upper edge of the first plate portion 42 and the upper edge of the second plate portion 46 are substantially at the same position in the up-down direction. When the busbar 40 is in a free state, the first plate portion 42 and the second plate portion 46 are located substantially in the same plane.

The first rising wall 50 and the second rising wall 52 are respectively connected to the opposing edges of the body portion 43 and the second plate portion 46. Each of the first rising wall 50 and the second rising wall 52 has a substantially rectangular shape with its up-down dimension greater than its left-right dimension when viewed from the front. One edge of the first rising wall 50 in the left-right direction is connected to an edge of the body portion 43, and one edge of the second rising wall 52 in the left-right direction is connected to an edge of the second plate portion 46. When the busbar 40 is in a free state, the first rising wall 50 and the second rising wall 52 are substantially perpendicular to the first plate portion 42 and the second plate portion 46.

The front and rear edges of the central plate portion 54 are connected to the opposing edges of the second rising wall 52 and the first rising wall 50 that are opposite from the second plate portion 46 and the body portion 43, respectively. The central plate portion 54 has a substantially rectangular shape with its left-right dimension greater than its up-down dimension when viewed from the side. When the busbar 40 is in a free state, the central plate portion 54 is substantially perpendicular to the first rising wall 50 and the second rising wall 52, and is substantially parallel to the first plate portion 42 and the second plate portion 46.

A first welded portion (first connection portion) 58 is provided on the body portion 43 of the first plate portion 42, and a second welded portion (second connection portion) 60 is provided on the second plate portion 46. The first welded portion 58 and the second welded portion 60 have substantially the same shape. Specifically, each of the first welded portion 58 and the second welded portion 60 has a substantially circular shape when viewed from the side, with a through hole formed in its center. The first welded portion 58 and the second welded portion 60 are counterbored so as to have a thickness smaller than that of other regions of the body portion 43 and the second plate portion 46. As shown in FIG. 4, the first welded portion 58 and the second welded portion 60 are positioned above the central position 40C of the body portion 43 and the second plate portion 46 in the up-down direction. As shown in FIG. 4, in the busbar 40, the region between a straight line LU connecting the upper end of the first welded portion 58 and the upper end of the second welded portion 60 and a straight line LD connecting the lower end of the first welded portion 58 and the lower end of the second welded portion 60 is referred to as main electrical conduction region 45.

A slit (first through hole) 61 extending linearly in the front-rear direction when viewed from the side is formed at and near the upper edge of the main electrical conduction region 45 of the body portion 43, the first rising wall 50, the central plate portion 54, the second rising wall 52, and the second plate portion 46. That is, the slit 61 is also formed in four connection portions 48, 49, 55, 56 of the busbar 40. The connection portion 48 is a portion (ridge) that connects the body portion 43 and the first rising wall 50, and the connection portion 49 is a portion (ridge) that connects the first rising wall 50 and the central plate portion 54. The connection portion 55 is a portion (ridge) that connects the second plate portion 46 and the second rising wall 52, and the connection portion 56 is a portion (ridge) that connects the second rising wall 52 and the central plate portion 54.

A slit (second through hole) 62 extending linearly in the front-rear direction when viewed from the side is formed near the lower edge of the main electrical conduction region 45 of the body portion 43, the first rising wall 50, the central plate portion 54, the second rising wall 52, and the second plate portion 46. The slit 62 has substantially the same shape as that of the slit 61 when viewed from the side.

A slit 63 extending linearly in the front-rear direction when viewed from the side is formed in the region below the slit 62 of the body portion 43, the first rising wall 50, the central plate portion 54, the second rising wall 52, and the second plate portion 46. The slit 63 has substantially the same shape as that of the slits 61, 62 when viewed from the side.

Furthermore, as shown in FIGS. 3 and 4, five auxiliary slits (first auxiliary through holes) 70 extending from the body portion 43 across the connection portion 48, the first rising wall 50, and the connection portion 49 into the central plate portion 54 are formed in each busbar 40. Five auxiliary slits (second auxiliary through holes) 75 extending from the second plate portion 46 across the connection portion 55, the second rising wall 52, and the connection portion 56 into the central plate portion 54 are also formed in each busbar 40. The uppermost auxiliary slits 70, 75 are located at the same position in the up-down direction above the slit 61. The second highest auxiliary slits 70, 75 are located at the same position in the up-down direction between the slit 61 and the slit 62. The third highest auxiliary slits 70, 75 are located at the same position in the up-down direction between the slit 62 and the slit 63. The fourth highest auxiliary slits 70, 75 are located at the same position in the up-down direction, and the fifth highest auxiliary slits 70, 75 are located at the same position in the up-down direction.

As is clear from FIGS. 3 and 4, the overall length of each auxiliary slit 70, 75 is shorter than that of each slit 61, 62, 63. The slits 61, 62, 63 and the auxiliary slits 70, 75 have substantially the same width in the up-down direction.

As shown in FIGS. 1 and 2, each busbar 40 is welded to a positive terminal 13P and a negative terminal 13N provided on either the left or right side surfaces of two adjacent battery cells 11. Each of the first welded portions 58 of the busbars 40 provided on the left side of the battery cells 11 is welded to the negative terminal 13N of the corresponding battery cell 11 using a laser beam emitted from a welding device (not shown) located to the left of the busbars 40. In addition, each of the second welded portions 60 of these busbars 40 is welded to the positive terminal 13P of the corresponding battery cell 11 using a laser beam emitted from the welding device. Each of the first welded portions 58 of the busbars 40 provided on the right side of the battery cells 11 is welded to the positive terminal 13P of the corresponding battery cell 11 using a laser beam emitted from a welding device located to the right of the busbars 40. In addition, each of the second welded portions 60 of these busbars 40 is welded to the negative terminal 13N of the corresponding battery cell 11 using a laser beam emitted from the welding device. That is, in the battery module 10 of the present embodiment, the battery cells 11 are connected in series by the busbars 40.

Once the busbars 40 are welded to the positive terminals 13P and negative terminals 13N of the battery cells 11 in this manner, the battery module 10 is completed. The battery module 10 thus assembled is housed in a case, and the case is fixed to the vehicle body.

### Functions and Effects

Next, the functions and effects of the embodiment will be described.

When current flows between the positive terminal 13P and the negative terminal 13N connected by the busbar 40, the current flows through a region of the busbar 40 between the first welded portion 58 and the second welded portion 60. Hereinafter, the region of the busbar 40 through which the current flows will be referred to as electrical conduction path 41. The electrical conduction path 41 is a region larger than the main electrical conduction region 45. That is, current may flow through a region above the main electrical conduction region 45 of the busbar 40 or through a region below the main electrical conduction region 45 of the busbar 40. The main electrical conduction region 45 is a region where current flows particularly readily among the electrical conduction path 41.

The connection portions 48, 55 of each busbar 40 of the present embodiment are portions that have a significant influence on the rigidity of the busbar 40. The connection portions 49, 56 are also portions that have a significant influence on the rigidity of the busbar 40. The five auxiliary slits 70 are formed in the connection portions 48, 49 of the busbar 40, and the five auxiliary slits 75 are formed in the connection portions 55, 56 of the busbar 40. Accordingly, although the auxiliary slits 70, 75 are smaller (shorter) than the slits 61, 62, 63, forming the auxiliary slits 70, 75 in the connection portions 48, 49, 55, 56 allows the rigidity of the busbar 40 to be reduced by the auxiliary slits 70, 75. Therefore, for example, when an external force in the up-down direction is applied from the battery cells 11 to the busbars 40 due to vibration during travel of the vehicle, or when each battery cell 11 expands and contracts, the busbars 40 can flexibly deform to absorb the external force. This configuration reduces the likelihood that the first welded portion 58 and the second welded portion 60 of each busbar 40 will separate from the corresponding positive terminal 13P or negative terminal 13N in such a case.

The auxiliary slits 70, 75 are smaller (shorter) than the slits 61, 62, 63. Therefore, although part of the auxiliary slits 70, 75 is formed in the electrical conduction path 41, the auxiliary slits 70, 75 are less likely to cause a significant increase in the electrical resistance of the busbar 40, and are also less likely to cause a significant reduction in the heat dissipation region of the busbar 40. As a result, the busbars 40 are less likely to become high in temperature. In addition, current can easily flow between the first welded portion 58 and the second welded portion 60 of each busbar 40.

As described above, the main electrical conduction region 45 is a region where current flows particularly readily among the electrical conduction path 41. In each busbar 40, part of the auxiliary slits 70, 75 is located above or below the main electrical conduction region 45. Therefore, the electrical resistance of the busbar 40 is less likely to increase compared to a case where all of the auxiliary slits 70, 75 are formed in the main electrical conduction region 45.

The first welded portion 58 and the second welded portion 60 are located above the central position 40C of the busbar 40, and the slits 61, 62, the upper two auxiliary slits 70, and the upper two auxiliary slits 75 are also located above the central position 40C. The opening area of the slits 61, 62 (63) is larger than that of the auxiliary slits 70, 75. Therefore, when a first total value is defined as the total opening area of the slits 61, 62, 63 and all of the auxiliary slits 70, 75, and a second total value is defined as the total opening area of the slits 61, 62, the upper two auxiliary slits 70, and the upper two auxiliary slits 75, a value obtained by dividing the second total value by the first total value is greater than 0.5 (50%). That is, among the slits 61, 62, 63 and all the auxiliary slits 70, 75, most are formed near the first welded portion 58 and the second welded portion 60 of the busbar 40. Therefore, the rigidity in the region around the first welded portion 58 and the second welded portion 60 of the busbar 40 is reduced compared to a case where the value obtained by dividing the second total value by the first total value is 0.5 or less. This configuration reduces the likelihood that the first welded portion 58 and the second welded portion 60 of each busbar 40 will separate from the corresponding positive terminal 13P or negative terminal 13N when an external force is applied from the battery cells 11 to the busbars 40, compared to the case where the value obtained by dividing the second total value by the first total value is 0.5 or less.

Although the busbar according to the embodiment has been described above, various design modifications can be made as appropriate without departing from the spirit and scope of the present disclosure.

For example, the auxiliary slits 70, 75 may be formed only above or below the main electrical conduction region 45.

The auxiliary slits 70, 75 may be provided in the connection portions 48, 55, but not in the connection portions 49, 56.

The first welded portion 58 and the second welded portion 60 may be located below the central position 40C of the busbar 40. In this case, when the first total value is defined as the total opening area of the slits 61, 62, 63 and all of the auxiliary slits 70, 75, and the second total value is defined as the total opening area of the slits 61, 62, 63 and the auxiliary slits 70, 75 located below the central position 40C, it is preferable that the value obtained by dividing the second total value by the first total value be greater than 0.5 (50%).

The slit 63 may be omitted from the busbar 40. In addition to the slits 61, 62, 63, a slit extending in the front-rear direction from the body portion 43 across the first rising wall 50, the central plate portion 54, and the second rising wall 52 into the second plate portion 46 may be formed in the busbar 40.

The vehicle may be an electrified vehicle equipped with an electric motor that uses the power of the battery module, rather than a battery electric vehicle. For example, the vehicle may be a hybrid electric vehicle or a plug-in hybrid electric vehicle.

What is claimed is:

1. A busbar having a plate shape and made of an electrically conductive material, terminals being provided on two surfaces of each of two battery cells arranged in a predetermined direction, the busbar being configured to be connected to the terminals on one of the two surfaces of each of the battery cells, the two surfaces facing each other in a perpendicular direction that is perpendicular to both the predetermined direction and an up-down direction, the busbar comprising:
a first plate portion including a first connection portion configured to be connected to the terminal of one of the two battery cells;
a second plate portion including a second connection portion configured to be connected to the terminal of the other of the two battery cells;
a first rising wall extending away from the battery cells in the perpendicular direction from an edge of the first plate portion that faces the second plate portion;
a second rising wall extending away from the battery cells in the perpendicular direction from an edge of the second plate portion that faces the first plate portion;
a central plate portion connecting opposing edges of the first rising wall and the second rising wall; and
a first through hole and a second through hole that are provided in a region between the first connection portion and the second connection portion and are arranged in the up-down direction, wherein:
a first auxiliary through hole is provided at a connection portion between the first rising wall and the first plate portion; and
a second auxiliary through hole is provided at a connection portion between the second rising wall and the second plate portion.

2. The busbar according to claim 1, wherein:
the first auxiliary through hole is provided in a connection portion between the first rising wall and the central plate portion; and
the second auxiliary through hole is provided in a connection portion between the second rising wall and the central plate portion.

3. The busbar according to claim 1, wherein the first auxiliary through hole and the second auxiliary through hole are located above, below, or both above and below a region between a straight line connecting an upper end of the first connection portion and an upper end of the second connection portion and a straight line connecting a lower end of the first connection portion and a lower end of the second connection portion.

4. The busbar according to claim 1, wherein:
the first connection portion and the second connection portion are located on either an upper side or a lower side relative to a central position of the busbar in the up-down direction; and
a total opening area of portions of the first through hole, the second through hole, the first auxiliary through hole, and the second auxiliary through hole located on the same side relative to the central position as the first connection portion and the second connection portion is greater than 50% of a total opening area of the first through hole, the second through hole, the first auxiliary through hole, and the second auxiliary through hole.
